(19) United States
(12) Patent Application Publication
(10) Pub. No.: US 2008/0129810 A1
(43) Pub. Date: Jun. 5, 2008

(54) COMPLIANT CHAMBER WITH CHECK VALVE AND INTERNAL ENERGY ABSORBING ELEMENT FOR INKJET PRINTHEAD

(75) Inventor: Charles S. Tamarin, New Rochelle, NY (US)

Correspondence Address: Levenfeld Pearlstein, LLC (ILLINOIS TOOL WORKS), 2 North LaSalle Street, Suite 1300, Chicago, IL, 60602, US

(73) Assignee: ILLINOIS TOOL WORKS, INC., Glenview, IL (US)

(21) Appl. No.: 11/935,550

(22) Filed: Nov. 6, 2007

Related U.S. Application Data
(60) Provisional application No. 60/868,236, filed on Dec. 1, 2006.

(51) Int. Cl. B41J 2/17

(52) U.S. Cl. 347/94

(57) ABSTRACT

A compliant chamber for use in a fluidic ink jetting system having a jetting device, such as a printhead, and a fluid reservoir, the compliant chamber comprising a chamber body having an inlet for a fluid and an outlet for the fluid, the body defining an open region therein, a cover for closing the body and for further defining the open region, and a resilient material disposed in the open region, the resilient material being an energy absorbing material, wherein fluidic pressure fluctuations are absorbed by the resilient material in the open region. A method of using such is also disclosed.

### BACKGROUND OF THE INVENTION

The present invention relates to impulse fluid ink jets which eject a droplet of fluid such as ink in response to the energization of a transducer.

Impulse fluid or ink jets are designed and driven so as to eject a droplet of fluid such as ink on demand from a chamber through an orifice in the chamber. Ink jets are utilized in many applications including industrial applications. In these applications, it is important that the ink jets operate reliably. Reliability can be reduced when there are pressure disturbances in the ink jet system. Such disturbances can occur during ink jet head shuttling, or due to external forces, for example, a shock to the printer apparatus.

An impulse fluid jet apparatus with depriming protection is disclosed in Duong et al., U.S. Pat. No. 6,209,997, which patent is commonly owned with the present application and is incorporated herein by reference. The device disclosed in the patent to Duong uses a diaphragm to form a compliant chamber that is vented to atmosphere.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a schematic illustration of a fluid delivery system having a compliant chamber embodying the principles of the present invention;

FIGS. 2A and 2B are side views showing the compliant chamber and various alternate orientations for the chamber relative to the environment and the fluid jet (print engine);

FIG. 3 is a perspective view of a first embodiment of the compliant chamber;

FIG. 4 is a plan view of the first embodiment compliant chamber;

FIGS. 5 and 6 are perspective views an embodiment of the chamber, shown with the chamber open for viewing the inside of the body and the cover, and with the foam insert in the open chamber area;

FIG. 7 is a perspective view of the base of the first embodiment of the compliant chamber assembly;

FIG. 8 is a perspective view of a second embodiment of the compliant chamber in a tubular or cylindrical form, showing the foam in a helical shape;

FIG. 9 is a perspective view of a third embodiment of a partially cut away tubular compliant chamber.

FIG. 10 is a perspective view of a fourth embodiment of the chamber, showing the chamber in an exploded view.

### DETAILED DESCRIPTION OF THE INVENTION

While the present invention is susceptible of embodiment in various forms, there is shown in the figures and will hereinafter be described a presently preferred embodiment with the understanding that the present disclosure is to be considered an exemplification of the invention and is not intended to limit the invention to the specific embodiment illustrated.

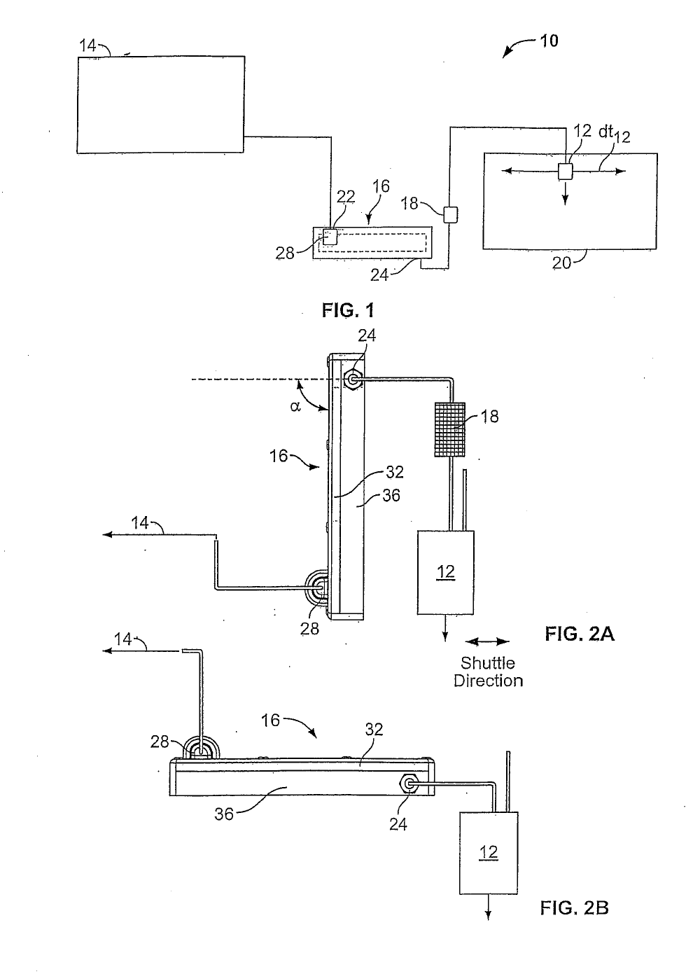

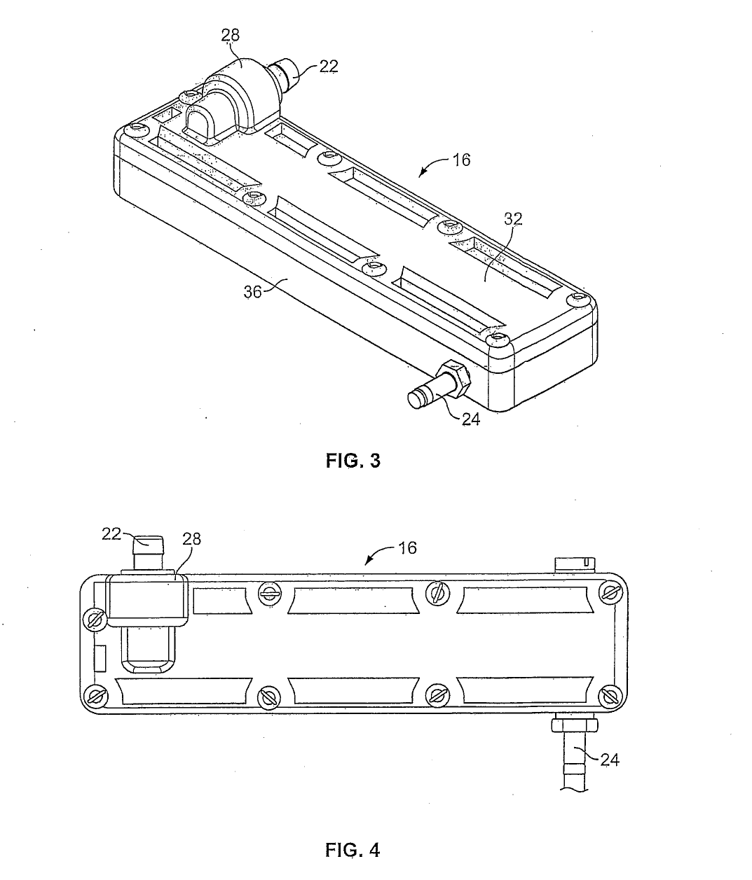

Referring to the figures and in particular to FIGS. 1 and 2 there is shown an impulse or ink jet printing system 10. Generally, the system 10 includes a jetting device or engine 12, such as an ink jet printhead, and a fluid reservoir or ink supply 14. A compliant chamber assembly 16 is disposed between the reservoir 14 and the printhead 12 and in a preferred arrangement, an external filter 18 is positioned in the system 10 between the compliant chamber assembly 16 and the printhead 12 (that is, downstream of the chamber assembly 16 and upstream of the printhead 12). The compliant chamber 16 can be positioned at any angle α between the engine 12 and the ink reservoir 14, and shuttles with the engine (printhead) 12.

The chamber 16 is designed to attenuate pressure disturbances created, for example, during shuttling motion, as shown by the arrows at FIGS. 1 and 2A, of the printhead 12 on a device such as a plotter or printer 20. The compliant chamber 16 design permits mounting the chamber 16 externally or separated from the printhead 12. Accordingly, the chamber 16 can shuttle with the printhead 12, or can be stationary relative to the printhead 12.

The compliant chamber assembly 16 is a closed chamber (that is having an inlet 22 and an outlet 24) and is not vented to the atmosphere. An open area 26, hence the chamber, is between the inlet 22 and the outlet 24. In a preferred configuration, a check valve 28 is present at the inlet 22 to prevent backflow from the chamber 26 to the ink reservoir 14.

Known compliant devices use a deflecting membrane which is exposed to the atmosphere to dampen fluidic motion due to tube shock and head motion.

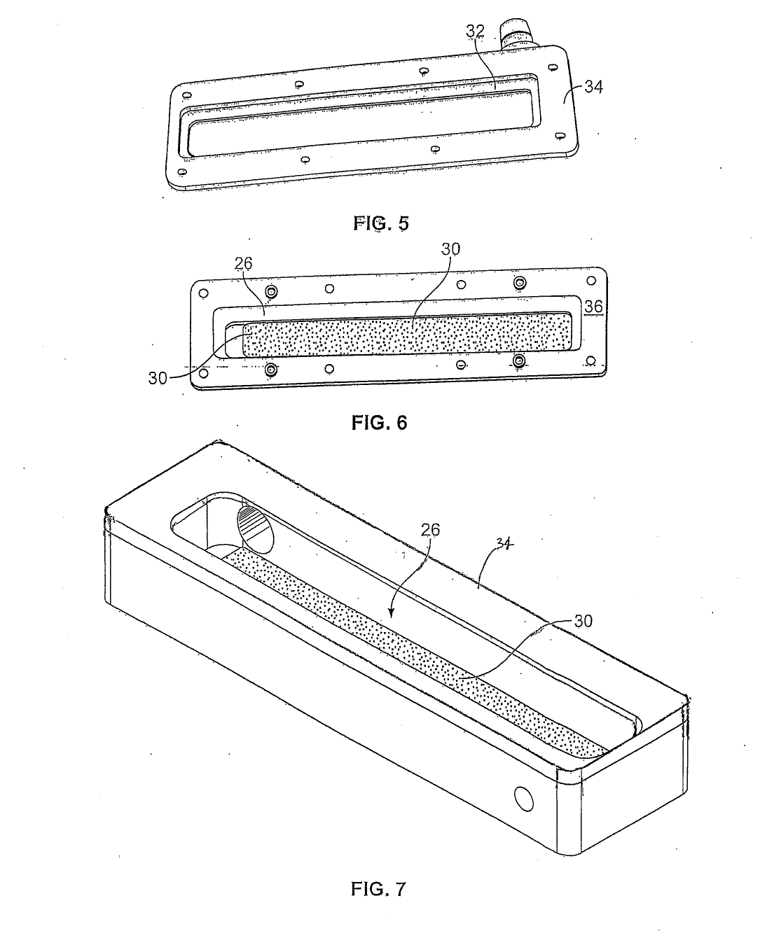

Turning to FIGS. 5-7, in the present compliant chamber 16, an energy absorbing or dampening element 30 is present in the chamber 26. A present element 30 is formed from an internal, closed cell foam. The foam 30 is compressed by the fluid (e.g., during movement of the printhead 12) and returns to its original state by releasing the stored energy and creating an offsetting positive pressure at the meniscus of the jetting device 12 orifice more slowly than would otherwise occur without a dampening device. It has been found that the use of a foam energy absorbing element 30 smoothes the fluidic motion and minimizes abrupt changes in orifice meniscus pressure which could otherwise cause channel drop out and deprime as the acceleration and velocity are increased during shuttling. The present compliant chamber device 16 has been found to help maintain a more constant pressure at the orifice meniscus.

It is contemplated that the energy absorbing element 30 can be made from differing densities and materials, changing the amount of compliance within the energy absorbing element 30. The absorbing element 30 may be of one density for differing performance requirements. It is also contemplated that the absorbing element 30 have differing densities within the same element 30, improving the response to differing pulses.

The check valve 28 at the inlet 22 to the chamber 16 has an upstream side that faces the fluid supply 14 and a downstream side that faces the open chamber 26. A present valve 28 is a normally closed, spring-loaded valve configured to open to allow forward fluid flow to the printhead 12 from the ink supply 14 when the pressure exceeds both the spring force and the pressure in the downstream side of the check valve 28.

The check valve 28 closes to prevent reverse fluid flow from the orifice back to the ink supply 14 when the pressure on the upstream side is less than or equal to the fluid pressure on the downstream side. This further prevents a pressure wave that could otherwise deprime the orifice.

In a present embodiment, the compliant chamber assembly 16 is configured as an external chamber having a sealed cover 32 (that is not open to atmospheric pressure) and a low density cross-linked foam 30 insert in the chamber 26.

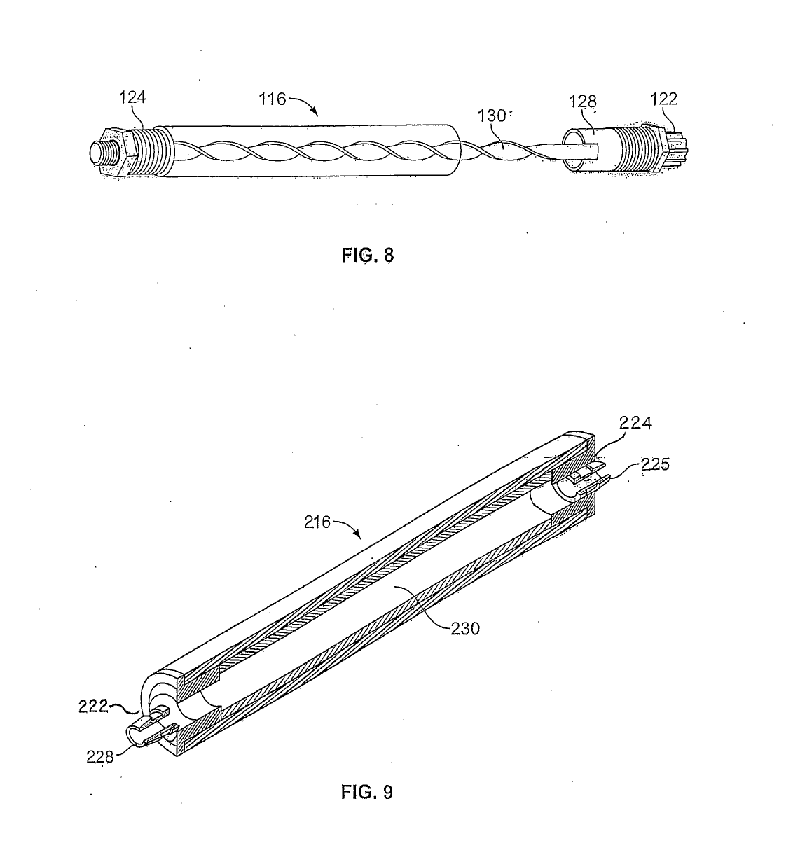

Alternate configurations are shown in FIGS. 8 through 10. FIG. 8 illustrates an embodiment in which the compliant chamber assembly 116 is constructed as a tubular element with a check valve 128 at an inlet end 122 and a twisted corkscrew or helical element 130 as the energy absorbing element.

FIG. 9 illustrates an embodiment of the compliant chamber 216 in which a plain barb fitting 225 is on the outlet end 224 and a check valve 228 is at the inlet 222. The inside foam element is configured as a hollow tube 230.

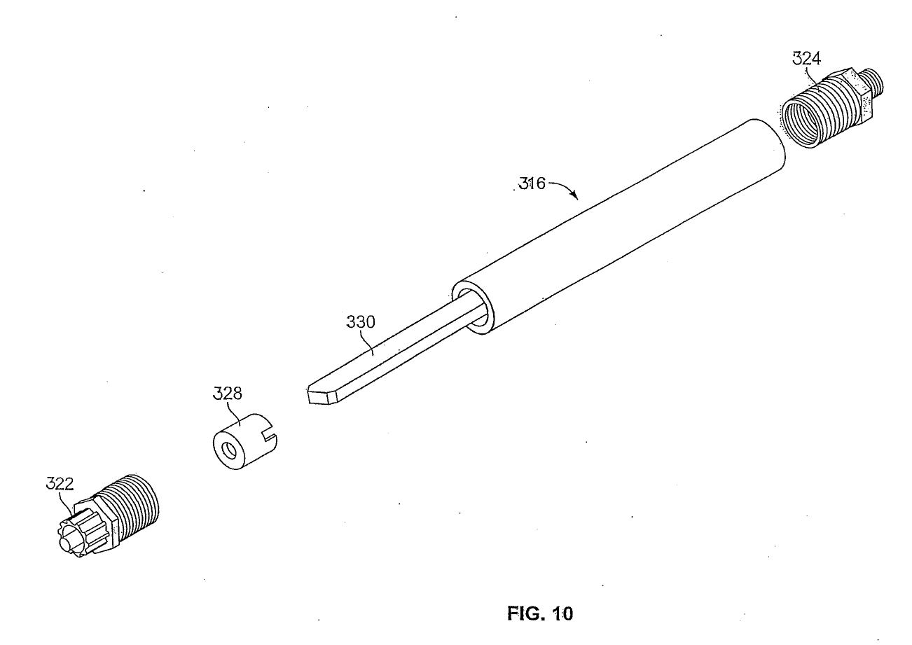

FIG. 10 illustrates another embodiment of the compliant chamber 316 in which a flat rectangular element 330 is provided for energy absorption within a tubular chamber 316. A check valve 328 is located at the inlet 322 and the outlet is located at 324. As is illustrated, various embodiments and configurations and permutations thereof are contemplated and within the scope and spirit of this invention.

Tests were conducted to determine the effectiveness of the present chamber. A standard Trident 768Jet inkjet printhead (commercially available from ITW Trident of Brookfield, Conn.) was the baseline for comparison of the present chamber design. The standard 768Jet could shuttle without channel loss at 28 inches per second (ips), 40 ips and 60 ips at up to 2 g acceleration. The test image was run at 180 dpi with 60% random fill for the 28 and 40 ips testing and 100 dpi with 60% random fill. The velocity and acceleration needed to meet requirements of 20 cm distance to reach the desired velocity are shown below:

### Plotter Requirements:

| | | Acceleration |
|---|---|---|
| Distance to reach velocity | Velocity | required |
| 7.77 in (20 cm) | 28 ips (.71 m/s) | .13 g |
| 7.77 in (20 cm) | 40 ips (1 m/s) | .27 g |
| 7.77 in (20 cm) | 60 ips (1.5 m/s) | .6 g |

The design goal was to meet the 768Jet baseline performance which greatly exceeds these minimums requirements and would result in a very robust product that could also meet future demands.

Configurations were tested which included: (1) the standard 768Jet design (having a diaphragm-type chamber, check valve and filter); (2) a modified 768Jet design (modified to remove the diaphragm from the compliant chamber, the check valve and the filter); and (3) a 768Jet design (again modified to remove the diaphragm from the chamber, the check valve and the filter), used in series with the present compliant chamber with an internal check valve and an external filter. In the chamber of the present design, a closed cell cross linked polyethylene foam (Valora 2 pcf) was inserted to the open chamber area. The chamber 16 was mounted to shuttle with the printhead 12. It was found that the foam-containing compliant chamber provided the same level of performance as the flexible membrane approach.

In a current compliant chamber 16, as seen in FIGS. 6 and 7, the foam element 30 is about 4 inches long and about ½ inch wide (extending over almost the entire length of the interior area of the chamber and across the entire width of the chamber) and is about ⅛ inch thick (the height of the chamber was ⅜ to ½ inches). The foam is affixed in place by an adhesive to prevent shifting. It will appreciated that other dimensions and methods to affix the foam may also be used.

As set forth above, the chamber 16 is not vented to atmosphere; accordingly, the entire chamber 16 is sealed. The chamber 16 can be formed with a gasket or seal 34 between the body 36 of the chamber 16 and the cover 32, or the cover 32 can be affixed (by a compatible adhesive, welding or the like) directly to the body 36.

Consideration is to be given to the orientation of the check valve 28 present in the system 10. A typical check valve uses a spring actuated plug or disk to isolate or permit flow. When the flow is in the “correct” direction, the pressure of the fluid overcomes the (often minimal) spring force, which moves the plug or disk off of a seat to allow fluid flow. When flow stops or is in a reverse direction, the spring force seats the plug or disk on the valve seat. There is thus a direction in which the valve “moves” that is the same direction as fluid flow through the valve.

It has been found that the check valve 28 should be mounted in the system in a direction other than the direction of travel dt₁₂ of the fluid jet 12 (the print head). This prevents pressure fluctuations due to print head shuttling from opening and closing (e.g., cycling) the check valve 28. It has also been found that the chamber 16 can in most cases be mounted in any orientation (e.g., horizontal, vertical, askew) preferably to shuttle with the printhead 12, and will function properly. Consideration here should be given to the overall operation of the fluid (ink) supply system 10, such as to prevent air bubbles and the like. It will also be appreciated that the present chamber 16 can be retrofitted into existing print systems.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the claims.

What is claimed is:

1. A compliant chamber for use in a fluidic ink jetting system having a jetting device, such as a printhead, and a fluid reservoir, the compliant chamber comprising:
a chamber body having an inlet for a fluid and an outlet for the fluid, the body defining an open region therein;
a cover for closing the body and for further defining the open region; and
a resilient material disposed in the open region, the resilient material being an energy absorbing material,
wherein fluidic pressure fluctuations are absorbed by the resilient material in the open region.

2. The compliant chamber as in claim 1 wherein the compliant chamber is mounted separate from the printhead.

3. The compliant chamber of claim 1 wherein the compliant chamber is not vented.

4. The compliant chamber of claim 1 wherein the energy absorbing material smoothes fluidic motion.

5. The compliant chamber of claim 1 wherein the energy absorbing material minimizes abrupt changes in an orifice meniscus.

6. The compliant chamber of claim 1 wherein the energy absorbing material is foam.

7. The compliant chamber of claim 6 wherein the foam is a low-density cross-linked foam.

8. The compliant chamber of claim 6 wherein the foam is compressed by fluid and returns to its original state.

9. The compliant chamber of claim 6 wherein the foam is shaped to optimize energy absorption.

10. The compliant chamber of claim 1 wherein a check valve is present at the inlet.

11. The compliant chamber of claim 10 wherein the check valve prevents backflow from the chamber to the fluid reservoir.

12. The compliant chamber of claim 10 wherein the check valve has an upstream side that faces the fluid reservoir.

13. The compliant chamber of claim 10 wherein the check valve has a downstream side that faces the open region.

14. The compliant chamber of claim 10 wherein the check valve is a normally-closed, spring loaded valve.

15. The compliant chamber of claim 10 wherein the check-valve is configured for fluid flow to the printhead.

16. The compliant chamber of claim 10 wherein the check valve prevents a pressure wave.

17. The compliant chamber of claim 1 wherein a filter is positioned downstream of the chamber.

18. A compliant chamber for use in a fluidic ink jet system having a jetting device such as a printhead and a fluid reservoir, the compliant chamber comprising:
a tubular housing having an inlet for fluid and an outlet for fluid, the tubular element defining an open region therein;
a check-valve at the inlet;
a fitting at the outlet; and
an energy absorbing component disposed within the open region.

19. The compliant chamber of claim 18 wherein the energy absorbing component is foam.

20. The compliant chamber of claim 18 wherein the energy absorbing component is shaped to optimize energy absorption.

21. The compliant chamber of 18 wherein the check valve is mounted such that cycling of the check valve does not cause pressure fluctuations in the printhead.

22. The compliant chamber of claim 18 wherein the chamber is mounted in any orientation.

23. The compliant chamber of claim 18 wherein a filter is positioned downstream of the chamber.

24. A method for preventing fluidic pressure fluctuations in a fluidic ink jet system having a fluid reservoir and a printhead, the method comprising:
disposing a closed chamber body between the fluid reservoir and the printhead;
disposing an energy absorbing component within the chamber body;
passing a fluid from the fluid reservoir through the chamber body prior to the fluid entering the printhead such that the energy absorbing material absorbs pressure fluctuations in the fluid.
